(19) United States
(12) Patent Application Publication
(10) Pub. No.: US 2026/0273855 A1
(43) Pub. Date: Sep. 17, 2026

(54) THREE-DIMENSIONAL SHAPING APPARATUS

(71) Applicant: SEIKO EPSON CORPORATION, Tokyo (JP)

(72) Inventor: Eiji OKAMOTO, MATSUMOTO-SHI (JP)

(21) Appl. No.: 19/562,954

(22) Filed: Mar. 11, 2026

(30) Foreign Application Priority Data
Mar. 14, 2025 (JP) 2025-041761

(51) Int. Cl. B29C 64/336; B29C 64/209; B33Y 30/00; B33Y 40/00

(52) U.S. Cl. CPC B29C 64/336; B29C 64/209; B33Y 30/00; B33Y 40/00

(57) ABSTRACT

A three-dimensional shaping apparatus is configured including: a plasticizing unit configured to plasticize at least a part of a shaping material containing a thermoplastic resin to generate a plasticized material; a fiber material supply unit configured to supply a fiber material; a nozzle configured to discharge the plasticized material and the fiber material toward a stage; and an ultrasonic wave applying unit configured to apply ultrasonic waves to at least one of the plasticized material and the fiber material, in which a distance between the nozzle and the stage is larger than a distance between the ultrasonic wave applying unit and the stage.

### CROSS-REFERENCE TO RELATED APPLICATION

The present application is based on, and claims priority from JP Application Serial Number 2025-041761, filed Mar 14, 2025, the disclosure of which is hereby incorporated by reference herein in its entirety.

### BACKGROUND

### Technical Field

The present disclosure relates to a three-dimensional shaping apparatus.

### Related Art

There is known a three-dimensional shaping apparatus that shapes a three-dimensional shaped object by discharging a plasticized material from a nozzle toward a stage and curing the plasticized material.

For example, JP-A-2019-116104 discloses a three-dimensional printer that melts a fiber-reinforced composite material filament containing a matrix resin with a heater to manufacture a three-dimensional printed component.

JP-A-2019-116104 is an example of the related art.

For the three-dimensional printer as described above, it is desired to improve the strength of a shaped object.

### SUMMARY

A three-dimensional shaping apparatus according to an aspect of the present disclosure is configured including:

a plasticizing unit configured to plasticize at least a part of a shaping material containing a thermoplastic resin to generate a plasticized material;

a fiber material supply unit configured to supply a fiber material;

a nozzle configured to discharge the plasticized material and the fiber material toward a stage; and

an ultrasonic wave applying unit configured to apply ultrasonic waves to at least one of the plasticized material and the fiber material, in which

a distance between the nozzle and the stage is larger than a distance between the ultrasonic wave applying unit and the stage.

### BRIEF DESCRIPTION OF THE DRAWINGS

FIG. 1 is a diagram illustrating a three-dimensional shaping apparatus according to an embodiment.

FIG. 2 is a cross-sectional view schematically illustrating a discharging unit of the three-dimensional shaping apparatus according to the embodiment.

FIG. 3 is a perspective view schematically illustrating a flat screw of the three-dimensional shaping apparatus according to the embodiment.

FIG. 4 is a diagram schematically illustrating a barrel of the three-dimensional shaping apparatus according to the embodiment.

FIG. 5 is a perspective view schematically illustrating the three-dimensional shaping apparatus according to the embodiment.

FIG. 6 is a cross-sectional view schematically illustrating the three-dimensional shaping apparatus according to the embodiment.

FIG. 7 is a bottom view schematically illustrating a nozzle of the three-dimensional shaping apparatus according to the embodiment.

FIG. 8 is a bottom view schematically illustrating an ultrasonic wave applying unit of the three-dimensional shaping apparatus according to the embodiment.

FIG. 9 is a graph illustrating a relationship between a temperature and a complex viscosity.

FIG. 10 is a flowchart illustrating processing of a control unit of the three-dimensional shaping apparatus according to the embodiment.

FIG. 11 is a cross-sectional view illustrating shaping layer forming processing of the three-dimensional shaping apparatus according to the embodiment.

FIG. 12 is a cross-sectional view schematically illustrating a three-dimensional shaping apparatus according to a first modification of the embodiment.

FIG. 13 is a cross-sectional view schematically illustrating the three-dimensional shaping apparatus according to the first modification of the embodiment.

FIG. 14 is a cross-sectional view schematically illustrating a three-dimensional shaping apparatus according to a second modification of the embodiment.

FIG. 15 is a cross-sectional view schematically illustrating a three-dimensional shaping apparatus according to a third modification of the embodiment.

FIG. 16 is a cross-sectional view schematically illustrating a shaped object shaped in an experimental example.

FIG. 17 is an X-ray CT image of a shaped object of Example 1.

FIG. 18 is an X-ray CT image of a shaped object of Comparative Example 1.

FIG. 19 is a perspective view schematically illustrating a shaped object shaped in an experimental example.

FIG. 20 is a perspective view schematically illustrating a shaped object shaped in an experimental example.

FIG. 21 is a diagram illustrating a tensile test in a shaping layer.

FIG. 22 is a diagram illustrating a tensile test between shaping layers.

### DESCRIPTION OF EMBODIMENTS

A preferable embodiment of the present disclosure will be described below in detail with reference to the drawings. The embodiment to be described below does not unduly limit the content of the present disclosure described in the claims. Further, not all of the configurations described below are necessarily essential elements of the present disclosure.

### Three-Dimensional Shaping Apparatus

### 1.1. Overall Configuration

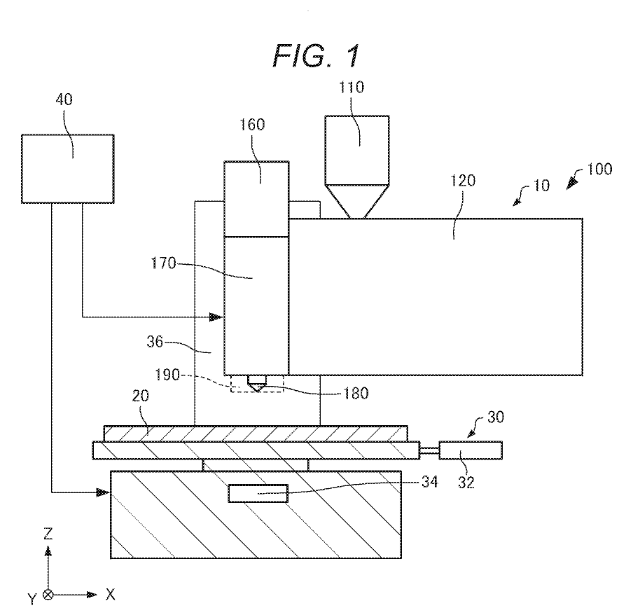

First, a three-dimensional shaping apparatus according to the embodiment will be described with reference to the drawings. FIG. 1 is a diagram illustrating a three-dimensional shaping apparatus 100 according to the embodiment. FIG. 1 illustrates an X axis, a Y axis, and a Z axis as three axes orthogonal to one another. An X-axis direction and a Y-axis direction are, for example, horizontal directions. A Z-axis direction is, for example, a vertical direction.

As illustrated in FIG. 1, the three-dimensional shaping apparatus 100 includes, for example, a discharging unit 10, a stage 20, a position changing unit 30, and a control unit 40. For convenience, in FIG. 1, the discharging unit 10 is illustrated in a simplified manner.

While causing the discharging unit 10 to discharge a plasticized shaping material toward the stage 20, the three-dimensional shaping apparatus 100 drives the position changing unit 30 to change relative positions of the discharging unit 10 and the stage 20. Accordingly, the three-dimensional shaping apparatus 100 shapes a shaped object having a desired shape by laminating shaping layers on the stage 20. The three-dimensional shaping apparatus 100 is a three-dimensional shaping apparatus of a fused deposition modeling (FDM) type.

Although not illustrated, a plurality of discharging units 10 may be provided. For example, two discharging units 10 may be provided. In this case, both of the two discharging units 10 may discharge the shaping material constituting the shaped object, or one may discharge the shaping material and the other may discharge a support material supporting the shaped object. The two discharging units 10 may be aligned in the X-axis direction.

The discharging unit 10 discharges the plasticized material and a fiber material toward the stage 20. The discharging unit 10 is movable relative to the stage 20. The discharging unit 10 will be described in detail later.

The stage 20 is provided below the discharging unit 10. In the illustrated example, the stage 20 is a rectangular parallelepiped. The shaping material and the fiber material discharged from the discharging unit 10 are deposited on the stage 20. The material of the stage 20 is, for example, metal such as aluminum.

The position changing unit 30 supports the stage 20. The position changing unit 30 changes relative positions of the discharging unit 10 and the stage 20. In the illustrated example, the position changing unit 30 moves the stage 20 in the X-axis direction and the Y-axis direction, thereby changing the relative positions of the discharging unit 10 and the stage 20 in the X-axis direction and the Y-axis direction. Further, the position changing unit 30 moves the discharging unit 10 in the Z-axis direction, thereby changing the relative positions of the discharging unit 10 and the stage 20 in the Z-axis direction.

The position changing unit 30 includes, for example, a first electric actuator 32, a second electric actuator 34, and a third electric actuator 36. The first electric actuator 32 moves the stage 20 in the X-axis direction. The second electric actuator 34 moves the stage 20 in the Y-axis direction. The third electric actuator 36 moves the discharging unit 10 in the Z-axis direction. The electric actuators 32, 34, and 36 are controlled by the control unit 40.

A configuration of the position changing unit 30 is not particularly limited as long as the position changing unit 30 can change the relative positions of the discharging unit 10 and the stage 20. For example, the position changing unit 30 may move the stage 20 in the Z-axis direction and move the discharging unit 10 in the X-axis direction and the Y-axis direction. The position changing unit 30 may move the stage 20 or the discharging unit 10 in the X-axis direction, the Y-axis direction, and the Z-axis direction.

The control unit 40 includes, for example, a computer including a processor, a main storage device, and an input and output interface for receiving and outputting signals from and to the outside. The processor executes programs read in the main storage device, whereby the control unit 40 exerts various functions. Specifically, the control unit 40 controls the discharging unit 10 and the position changing unit 30. The control unit 40 may include a combination of a plurality of circuits rather than the computer.

### Discharging Unit

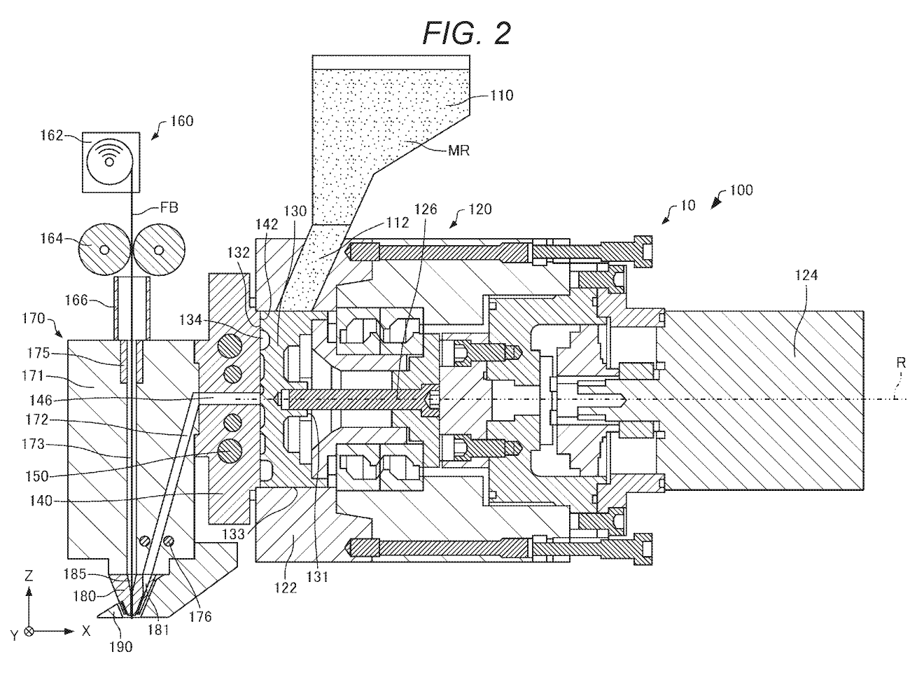

FIG. 2 is a cross-sectional view schematically illustrating the discharging unit 10 of the three-dimensional shaping apparatus 100. As illustrated in FIGS. 1 and 2, the discharging unit 10 includes, for example, a shaping material supply unit 110, a plasticizing unit 120, a fiber material supply unit 160, a block body 170, a nozzle 180, and an ultrasonic wave applying unit 190. For convenience, in FIG. 1, the ultrasonic wave applying unit 190 is illustrated in perspective.

As illustrated in FIG. 2, the shaping material supply unit 110 stores a shaping material MR. The shaping material supply unit 110 supplies the shaping material MR to the plasticizing unit 120. The shaping material supply unit 110 includes, for example, a hopper. The shaping material MR has, for example, a pellet form or a powder form.

The shaping material MR supplied from the shaping material supply unit 110 contains a thermoplastic resin. Examples of the thermoplastic resin include general-purpose plastic, general-purpose engineering plastic, and super engineering plastic. Examples of the general-purpose plastic include polypropylene (PP), polyethylene (PE), polyvinyl chloride (PVC), and polylactic acid (PLA). Examples of the general-purpose engineering plastic include polyacetal (POM), polyamide (PA), polycarbonate (PC), modified polyphenylene ether (m-PPE), polybutylene terephthalate (PBT), and polyethylene terephthalate (PET). Examples of the super engineering plastic include polysulfone (PSU), polyethersulfone (PES), polyphenylene sulfide (PPS), polyarylate (PAR), polyimide (PI), polyamide-imide (PAI), polyetherimide (PEI), and polyether ether ketone (PEEK).

The shaping material MR supplied from the shaping material supply unit 110 may include short fibers such as chopped carbon fibers. The fiber length of the short fibers is, for example, 10 μm or more and 500 μm or less, and is preferably 50 μm or more and 200 μm or less. The short fibers contained in the shaping material MR are not limited to carbon fibers, and may be glass fibers or fibers (Kevlar (registered trademark)) obtained by polymerization of p-phenylenediamine and terephthalic acid chloride. Since the shaping material MR contains the short fibers, the short fibers can be entangled with each other at boundaries of adjacent shaping layers among a plurality of shaping layers deposited on the stage 20, and strength at the boundaries of the adjacent shaping layers can be improved.

The shaping material MR supplied from the shaping material supply unit 110 may include a metal material and a ceramic material. Examples of the metal material include single metal such as magnesium (Mg), iron (Fe), cobalt (Co), chromium (Cr), aluminum (Al), titanium (Ti), copper (Cu), and nickel (Ni), an alloy containing one or more of these types of metal, maraging steel, stainless steel, cobalt chromium molybdenum, a titanium alloy, a nickel alloy, an aluminum alloy, a cobalt alloy, and a cobalt chromium alloy. Examples of the ceramic material include oxide ceramic such as silicon dioxide, titanium dioxide, aluminum oxide, and zirconium oxide, and non-oxide ceramic such as aluminum nitride.

The shaping material supply unit 110 and the plasticizing unit 120 are coupled by a supply path 112. The shaping material MR supplied to the shaping material supply unit 110 is supplied to the plasticizing unit 120 via the supply path 112.

The plasticizing unit 120 includes, for example, a screw case 122, a drive motor 124, a shaft 126, a flat screw 130, a barrel 140, and a heater 150.

The plasticizing unit 120 plasticizes at least a part of the shaping material MR in a solid state supplied from the shaping material supply unit 110, generates a plasticized material in a paste form having fluidity, and supplies the plasticized material to the block body 170. For convenience, the plasticized material is not illustrated in FIG. 2.

Plasticizing is a concept including melting, and means changing from a solid state to a state having fluidity. Specifically, in the case of a material in which glass transition occurs, plasticizing means setting a temperature of the material to a temperature equal to or higher than a glass transition point thereof. In the case of a material in which glass transition does not occur, plasticizing means setting the temperature of the material to a temperature equal to or higher than a melting point thereof.

The screw case 122 is a housing that accommodates the flat screw 130. In the illustrated example, the barrel 140 is provided on a side of the screw case 122. The flat screw 130 is accommodated in a space surrounded by the screw case 122 and the barrel 140.

The drive motor 124 is provided, for example, in a +X-axis direction of the flat screw 130. The drive motor 124 is, for example, a servo motor. The drive motor 124 is controlled by the control unit 40.

The shaft 126 is coupled to the drive motor 124 via, for example, a speed reducer. The shaft 126 is rotated by the drive motor 124. In the illustrated example, the shaft 126 extends in the X-axis direction. The shaft 126 rotates about an axis parallel to the X axis as a rotation axis R. The shaft 126 is coupled to the flat screw 130. The shaft 126 transmits a torque generated by the drive motor 124 to the flat screw 130.

The flat screw 130 is provided between the barrel 140 and the drive motor 124. The flat screw 130 has a substantially cylindrical shape, a dimension of which in a rotation axis R direction is smaller than a dimension in a direction orthogonal to the rotation axis R direction. The flat screw 130 is rotated about the rotation axis R by the torque generated by the drive motor 124.

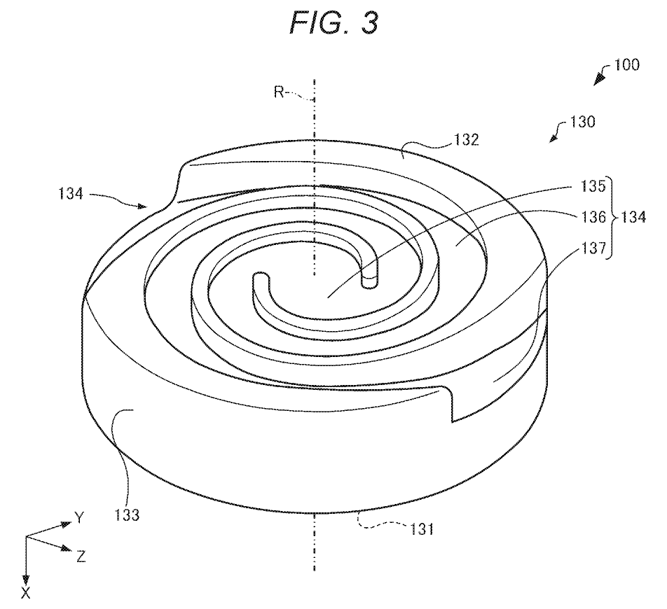

The flat screw 130 has, for example, a shaft surface 131 to which the shaft 126 is coupled, a groove forming surface 132 on an opposite side from the shaft surface 131, and a coupling surface 133 coupling the shaft surface 131 and the groove forming surface 132. A first groove 134 is formed in the groove forming surface 132. The coupling surface 133 is, for example, perpendicular to the groove forming surface 132. Here, FIG. 3 is a perspective view schematically illustrating the flat screw 130.

As illustrated in FIG. 3, the first groove 134 is formed in the groove forming surface 132 of the flat screw 130. The first groove 134 includes, for example, a central portion 135, a coupling portion 136, and a material introduction portion 137. The central portion 135 faces a communication hole 146 formed in the barrel 140. The central portion 135 communicates with the communication hole 146. The coupling portion 136 couples the central portion 135 and the material introduction portion 137. In the illustrated example, the coupling portion 136 is provided in a spiral shape from the central portion 135 toward an outer circumference of the groove forming surface 132. The material introduction portion 137 is provided at the outer circumference of the groove forming surface 132. That is, the material introduction portion 137 is provided at the coupling surface 133 of the flat screw 130. The material supplied from the material supply unit 110 is introduced from the material introduction portion 137 into the first groove 134, passes through the coupling portion 136 and the central portion 135, and is conveyed to the communication hole 146 formed in the barrel 140. For example, two first grooves 134 are formed.

The number of first grooves 134 is not particularly limited. Although not illustrated, three or more first grooves 134 may be formed or only one first groove 134 may be formed. Although not illustrated, the plasticizing unit 120 may include, rather than the flat screw 130, an elongated in-line screw including a spiral groove in a side surface thereof. The plasticizing unit 120 may plasticize the shaping material according to rotation of the in-line screw.

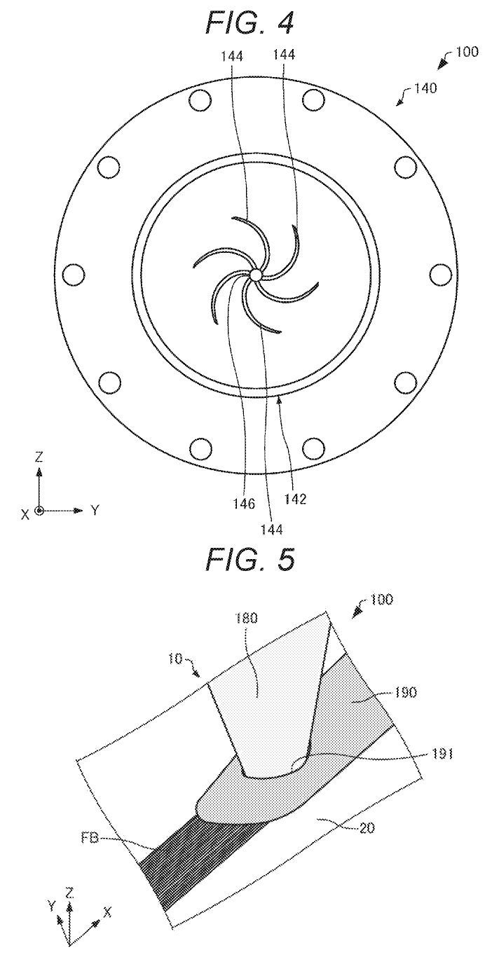

As illustrated in FIG. 2, the barrel 140 is provided on a side of the flat screw 130. The barrel 140 has a facing surface 142 facing the groove forming surface 132 of the flat screw 130. The communication hole 146 communicating with the first groove 134 is formed in the center of the facing surface 142. Here, FIG. 4 is a view schematically illustrating the barrel 140.

As illustrated in FIG. 4, a second groove 144 and the communication hole 146 are formed in the facing surface 142 of the barrel 140. A plurality of the second grooves 144 are formed. In the illustrated example, six second grooves 144 are formed. However, the number of second grooves 144 is not particularly limited. The plurality of second grooves 144 are formed around the communication hole 146 as viewed in the X-axis direction. One end of the second groove 144 is coupled to the communication hole 146 and extends spirally from the communication hole 146 toward the outer circumference of the barrel 140. The second groove 144 guides the plasticized material to the communication hole 146. The communication hole 146 extends, for example, in the X-axis direction.

Although not illustrated, the second groove 144 is not particularly limited in shape, and may have, for example, a linear shape. One end of the second groove 144 may not be coupled to the communication hole 146. Further, the second groove 144 may not be formed in the facing surface 142. However, in consideration of efficiently guiding the plasticized material to the communication hole 146, the second groove 144 is preferably formed in the facing surface 142.

As illustrated in FIG. 2, the heater 150 is provided in the barrel 140. The heater 150 heats the shaping material MR supplied between the flat screw 130 and the barrel 140. An output of the heater 150 is controlled by the control unit 40. The plasticizing unit 120 heats the shaping material MR while conveying the shaping material MR toward the communication hole 146 by the flat screw 130, the barrel 140, and the heater 150 to generate the plasticized material. Then, the plasticizing unit 120 causes the generated plasticized material to flow out from the communication hole 146.

Although not illustrated, the heater 150 may have a ring shape as viewed in the X-axis direction. The heater 150 may not be provided in the barrel 140, and may be provided in the vicinity of the barrel 140 at the block body 170.

The fiber material supply unit 160 is provided, for example, above the block body 170. The fiber material supply unit 160 supplies a fiber material FB to the nozzle 180 via the block body 170. The fiber material supply unit 160 includes, for example, an accommodating portion 162, a conveyance roller 164, and a conveyance path 166. The accommodating portion 162 accommodates the fiber material FB wound around a reel. The conveyance roller 164 is provided below the accommodating portion 162. The conveyance roller 164 includes a pair of rollers that sandwich the fiber material FB supplied from the accommodating portion 162 and convey the fiber material FB toward the conveyance path 166. The rotation of the conveyance roller 164 is controlled by the control unit 40. The conveyance path 166 is provided below the conveyance rollers 164. The conveyance path 166 is coupled to the block body 170. The conveyance path 166 has, for example, a cylindrical shape. The fiber material FB supplied from the conveyance roller 164 passes through the inside of the conveyance path 166 and is supplied to the block body 170.

The configuration of the fiber material supply unit 160 is not limited to the above example. For example, the fiber material supply unit 160 may supply a reel around which the fiber material FB is wound from the accommodating portion 162 to the block body 170 by rotation of a motor (not illustrated).

Examples of the fiber material FB supplied from the fiber material supply unit 160 include carbon fibers, glass fibers, and Kevlar (registered trademark). The fiber material FB supplied from the fiber material supply unit 160 is, for example, a fiber bundle in which a plurality of fibers are bundled up. The fiber material supply unit 160 supplies, for example, the fiber material FB that is a fiber bundle in which several thousands of fibers are bundled up. A diameter of the fiber material FB as the fiber bundle supplied from the fiber material supply unit 160 may be 0.1 mm or more, 0.3 mm or more, about 0.4 mm, or 1 mm or less. The number of fibers constituting the fiber bundle is not particularly limited. The fiber material supply unit 160 may supply one fiber as the fiber material FB.

The block body 170 is provided on a side of the barrel 140 and below the fiber material supply unit 160. The block body 170 is, for example, a substantially rectangular parallelepiped. The block body 170 includes, for example, a flow channel forming portion 171, a heat insulating portion 175, and a nozzle heater 176.

The material of the flow channel forming portion 171 is, for example, metal such as steel use stainless (SUS). A first block flow channel 172 and a second block flow channel 173 are formed in the flow channel forming portion 171. In the illustrated example, the first block flow channel 172 extends in a direction inclined with respect to the Z axis. The first block flow channel 172 communicates with the communication hole 146 formed in the barrel 140. The plasticized material is supplied to the first block flow channel 172 from the communication hole 146. The second block flow channel 173 extends in the Z-axis direction. The second block flow channel 173 communicates with the inside of the conveyance path 166 of the fiber material supply unit 160. The fiber material FB is supplied from the conveyance path 166 to the second block flow channel 173. The first block flow channel 172 and the second block flow channel 173 are separated from each other.

The heat insulating portion 175 is provided in the flow channel forming portion 171. The heat insulating portion 175 is coupled to the conveyance path 166 of the fiber material supply unit 160. In the illustrated example, the heat insulating portion 175 defines a part of the second block flow channel 173. Thermal conductivity of the heat insulating portion 175 is smaller than thermal conductivity of the flow channel forming portion 171. The material of the heat insulating portion 175 is, for example, ceramic, glass, polytetrafluoroethylene (PTFE), or silicone resin. The heat insulating portion 175 can reduce a possibility that the fiber material FB deteriorates due to heat of the heater 150 and heat of the nozzle heater 176.

The nozzle heater 176 is provided in the flow channel forming portion 171. The nozzle heater 176 is provided in the vicinity of the nozzle 180. The nozzle heater 176 heats the nozzle 180 and the plasticized material flowing through the first block flow channel 172. An output of the nozzle heater 176 is controlled by the control unit 40. A temperature of the nozzle heater 176 may be the same as a temperature of the heater 150 provided in the barrel 140. The nozzle heater 176 may have a ring shape surrounding the first block flow channel 172 as viewed from the Z-axis direction.

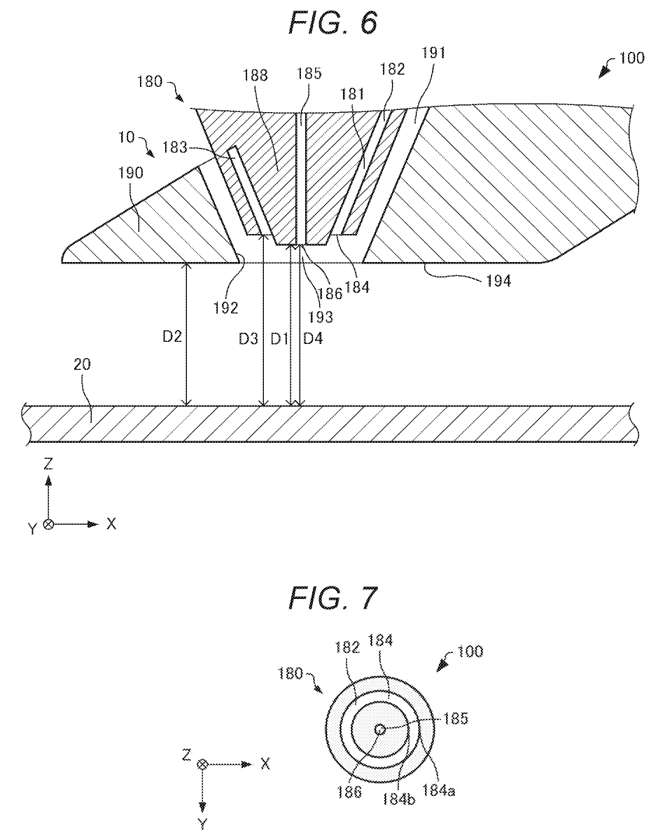

The nozzle 180 is coupled to the block body 170. The nozzle 180 is provided below the block body 170. The nozzle 180 discharges the plasticized material and the fiber material FB toward the stage 20. Here, FIG. 5 is a perspective view schematically illustrating the three-dimensional shaping apparatus 100. FIG. 6 is a cross-sectional view schematically illustrating the three-dimensional shaping apparatus 100. For convenience, in FIGS. 5 and 6, illustration of members other than the stage 20, the nozzle 180, and the ultrasonic wave applying unit 190 is omitted.

As illustrated in FIGS. 5 and 6, the nozzle 180 is inserted into a through hole 191 formed in the ultrasonic wave applying unit 190. In the illustrated example, the nozzle 180 has a reverse tapered shape in which a width thereof decreases toward a -Z-axis direction. As illustrated in FIGS. 2 and 6, the nozzle 180 has a first nozzle flow channel 181 and a second nozzle flow channel 185.

The first nozzle flow channel 181 communicates with the first block flow channel 172. The plasticized material is supplied from the first block flow channel 172 to the first nozzle flow channel 181. The first nozzle flow channel 181 is a flow channel for the plasticized material. The first nozzle flow channel 181 is coupled to the second nozzle flow channel 185. As illustrated in FIG. 6, the first nozzle flow channel 181 includes, for example, an inclined portion 182, a surrounding portion 183, and a first nozzle opening 184.

The inclined portion 182 of the first nozzle flow channel 181 is coupled to the first block flow channel 172. For example, the inclined portion 182 extends in the same direction as the first block flow channel 172. The inclined portion 182 has, for example, a portion linearly extending from the first block flow channel 172 toward the surrounding portion 183.

The surrounding portion 183 of the first nozzle flow channel 181 is coupled to the inclined portion 182. The surrounding portion 183 surrounds the second nozzle flow channel 185 as viewed from the Z-axis direction. The surrounding portion 183 has a shape that extends from the inclined portion 182 and surrounds the second nozzle flow channel 185. In the illustrated example, a distance between the surrounding portion 183 and the second nozzle flow channel 185 decreases toward the -Z-axis direction.

The first nozzle opening 184 of the first nozzle flow channel 181 is coupled to the surrounding portion 183. The first nozzle opening 184 discharges the plasticized material. The surrounding portion 183 couples the inclined portion 182 and the first nozzle opening 184. Here, FIG. 7 is a bottom view schematically illustrating the nozzle 180 of the three-dimensional shaping apparatus 100. As illustrated in FIG. 7, the first nozzle opening 184 has an annular shape as viewed from the Z-axis direction. The first nozzle opening 184 has an outer edge 184a and an inner edge 184b. The outer edge 184a and the inner edge 184b are curved. The outer edge 184a and the inner edge 184b do not have a corner. In the illustrated example, the outer edge 184a and the inner edge 184b have a circular shape. A center of the outer edge 184a and a center of the inner edge 184b are, for example, the same. In the illustrated example, the first nozzle opening 184 has a ring shape as viewed from the Z-axis direction. A second nozzle opening 186 of the second nozzle flow channel 185 is circular as viewed from the Z-axis direction. A position of a center of the ring-shaped first nozzle opening 184 and a position of a center of the circular second nozzle opening 186 coincide with each other, for example. The first nozzle opening 184 surrounds the second nozzle opening 186 as viewed from the Z-axis direction.

The second nozzle flow channel 185 communicates with the second block flow channel 173. The fiber material FB is supplied from the second block flow channel 173 to the second nozzle flow channel 185. The second nozzle flow channel 185 is a flow channel for the fiber material FB. In the example illustrated in FIG. 6, the second nozzle flow channel 185 extends in the Z-axis direction. The second nozzle flow channel 185 is surrounded by the first nozzle flow channel 181 as viewed from the Z-axis direction. The nozzle 180 has a flow channel separation portion 188 located between the first nozzle flow channel 181 and the second nozzle flow channel 185. The flow channel separation portion 188 is located between the surrounding portion 183 and the second nozzle flow channel 185. The flow channel separation portion 188 has, for example, a ring shape as viewed from the Z-axis direction.

The second nozzle flow channel 185 has the second nozzle opening 186 through which the fiber material FB is discharged. The second nozzle opening 186 is separated from the first nozzle opening 184. The plasticized material and the fiber material FB come into contact with each other to form a shaping layer after being discharged from the nozzle 180. The fiber material FB discharged from the second nozzle opening 186 may be continuous fibers connected up to the accommodating portion 162 of the fiber material supply unit 160. The nozzle 180 may continuously discharge the fiber material FB until the fiber material FB accommodated in the accommodating portion 162 runs out.

Although not illustrated, the discharging unit 10 may include a cutting unit that cuts the fiber material FB, which is supplied from the fiber material supply unit 160, to a predetermined length. The nozzle 180 may discharge the cut fiber material FB.

The ultrasonic wave applying unit 190 is coupled to, for example, the block body 170 such that ultrasonic vibration is not reduced. The ultrasonic wave applying unit 190 is provided below the block body 170. The ultrasonic wave applying unit 190 may be detachable from the block body 170. For example, the ultrasonic wave applying unit 190 may be held at any position where the positional relationship with the discharging unit 10 does not change so as not to hinder the ultrasonic vibration.

The ultrasonic wave applying unit 190 has the through hole 191. In the illustrated example, the through hole 191 runs through the ultrasonic wave applying unit 190 in the Z-axis direction. An inner wall 192 of the through hole 191 has a reverse tapered shape corresponding to the shape of the nozzle 180. The ultrasonic wave applying unit 190 surrounds the nozzle 180 as viewed from the Z-axis direction. The ultrasonic wave applying unit 190 is separated from the nozzle 180.

A distance D1 between the nozzle 180 and the stage 20 is larger than a distance D2 between the ultrasonic wave applying unit 190 and the stage 20. Therefore, the through hole 191 has a storage portion 193 surrounded by the inner wall 192 of the ultrasonic wave applying unit 190. The storage portion 193 is located in the -Z-axis direction of the nozzle 180. The plasticized material discharged from the first nozzle opening 184 accumulates in the storage portion 193 located between a lower shaping layer and the nozzle 180. Since the fiber material FB is discharged from the second nozzle opening 186 in a state where the plasticized material is accumulated in the storage portion 193, the fiber material FB is impregnated with the plasticized material and is covered with the plasticized material in the storage portion 193. When the nozzle 180 moves relative to the stage 20, the fiber material FB impregnated with the plasticized material is deposited on the stage 20.

In the illustrated example, a distance D3 between the first nozzle opening 184 and the stage 20 is larger than a distance D4 between the second nozzle opening 186 and the stage 20. The distance D4 is the same as the distance D1. The second nozzle opening 186 is located closer to the stage 20 than is the first nozzle opening 184.

The ultrasonic wave applying unit 190 generates ultrasonic waves by vibrating. A frequency of the ultrasonic waves generated by the ultrasonic wave applying unit 190 is, for example, 20 kHz or more and 60 kHz or less. Driving of the ultrasonic wave applying unit 190 is controlled by the control unit 40.

The ultrasonic wave applying unit 190 comes into contact with the plasticized material discharged from the nozzle 180 toward the stage 20. Accordingly, the ultrasonic wave applying unit 190 applies ultrasonic waves to the plasticized material discharged from the nozzle 180 toward the stage 20. Since the fiber material FB is impregnated with the plasticized material in the storage portion 193, the fiber material FB is deposited on the stage 20 while being surrounded by the plasticized material. The ultrasonic waves applied to the plasticized material by the ultrasonic wave applying unit 190 are transmitted to the fiber material FB via the plasticized material. Therefore, the ultrasonic wave applying unit 190 also applies the ultrasonic waves to the fiber material FB via the plasticized material. A part of the fiber material FB may be exposed from the plasticized material. In this case, the ultrasonic wave applying unit 190 may be in contact with the fiber material FB. The ultrasonic wave applying unit 190 may apply the ultrasonic waves only to the fiber material FB or may apply the ultrasonic waves only to the plasticized material.

When the ultrasonic wave applying unit 190 comes into contact with the plasticized material, the fiber material FB in a bundle shape is pressed and opened as illustrated in FIG. 5. Then, the fiber material FB is fixed to the lower shaping layer. The fiber material FB in a bundle shape is pressed by the ultrasonic wave applying unit 190 and becomes, for example, a ribbon shape. A width of the ribbon-shaped fiber material FB is, for example, 0.5 mm or more and 2 mm or less. A thickness of the ribbon-shaped fiber material FB is, for example, 0.05 mm or more and 0.3 mm or less, and is preferably 0.1 mm or more and 0.2 mm or less. The ribbon-shaped fiber material FB is impregnated with the plasticized material. For convenience, the plasticized material is not illustrated in FIG. 5.

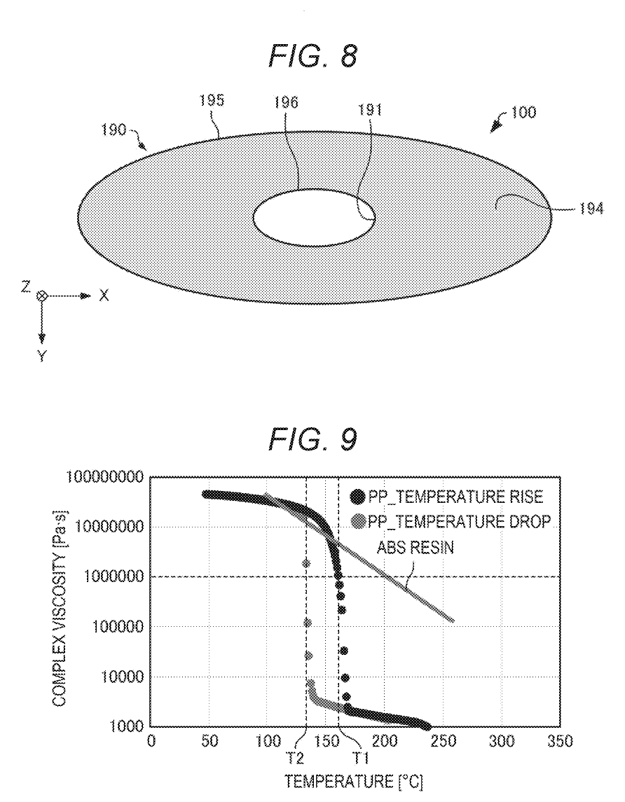

As illustrated in FIG. 6, the ultrasonic wave applying unit 190 has a contact surface 194 that comes into contact with the plasticized material discharged toward the stage 20. In the illustrated example, the contact surface 194 is a lower surface of the ultrasonic wave applying unit 190. Here, FIG. 8 is a bottom view schematically illustrating the ultrasonic wave applying unit 190.

As illustrated in FIG. 8, the contact surface 194 of the ultrasonic wave applying unit 190 has an annular shape as viewed from the Z-axis direction. Accordingly, even when the nozzle 180 moves relative to the stage 20 in any direction among directions orthogonal to the Z-axis direction, the discharged plasticized material can be pressed by the ultrasonic wave applying unit 190. The contact surface 194 has, for example, a doughnut shape. The contact surface 194 has, for example, an annular shape. The contact surface 194 has an outer edge 195 and an inner edge 196. The outer edge 195 and the inner edge 196 are curved. Accordingly, the plasticized material can be uniformly pressed by the ultrasonic wave applying unit 190. The outer edge 195 and the inner edge 196 do not have a corner. In the illustrated example, the outer edge 195 and the inner edge 196 have an elliptical shape. A center of the outer edge 195 and a center of the inner edge 196 are, for example, the same. The second nozzle opening 186 is located inside the inner edge 196 as viewed from the Z-axis direction.

A temperature of the ultrasonic wave applying unit 190 is lower than a temperature of the nozzle 180, for example. A thermoplastic resin contained in the shaping material MR is, for example, a crystalline resin. Examples of the crystalline resin include PP, PA, PBT, PPS, PEEK, and POM.

Here, FIG. 9 is a graph illustrating a relationship between a temperature and a complex viscosity of PP that is a crystalline resin and an ABS resin that is an amorphous resin. The complex viscosity was measured using a rheometer. In the three-dimensional shaping apparatus 100, the shaping material is heated by the plasticizing unit 120 to reduce the complex viscosity, and is discharged from the nozzle 180 as the plasticized material. The discharged plasticized material is cooled to increase the complex viscosity. When the plasticized material is discharged from the nozzle 180, the complex viscosity is preferably 100,000 Pa·s or less, and is more preferably 10,000 Pa·s or less. Therefore, it is necessary to increase the temperature of the nozzle 180. On the other hand, since the plasticized material deposited on the stage 20 needs to maintain its shape as a shaped object, the complex viscosity is preferably 1,000,000 Pa·s or more.

As illustrated in FIG. 9, the ABS resin, which is not a crystalline resin, has the same complex viscosity value during temperature rise and temperature drop at the same temperature. On the other hand, PP, which is a crystalline resin, has different complex viscosity values during temperature rise and temperature drop even at the same temperature. PP has a viscosity of 1,000,000 Pa·s at a temperature T1 during temperature rise, but does not have a viscosity of 1,000,000 Pa·s unless the temperature is decreased to a temperature T2 lower than the temperature T1 during temperature drop. Therefore, it is necessary to lower the temperature of the shaping layers deposited on the stage to the temperature T2 or lower. When a high-temperature shaping layer is newly laminated on the shaping layer having a low temperature equal to or lower than the temperature T2 as described above, strength at boundaries of both shaping layers decreases since a temperature difference between both shaping layers is large. When the temperature of the lower shaping layer is increased in order to reduce the temperature difference between both shaping layers, the shape of the shaping layer is distorted. Further, the fiber material may be deteriorated.

With respect to the above problem, in the three-dimensional shaping apparatus 100, boundaries of adjacent shaping layers can be fused by the ultrasonic waves of the ultrasonic wave applying unit 190. Therefore, even when the temperature of the ultrasonic wave applying unit 190 is lower than the temperature of the nozzle 180, the strength at the boundaries of the adjacent shaping layers can be improved. Even if the thermoplastic resin is not a crystalline resin, the viscosity of the thermoplastic resin can be reduced by the ultrasonic waves of the ultrasonic wave applying unit 190. Therefore, the ultrasonic waves of the ultrasonic wave applying unit 190 are also effective for an amorphous thermoplastic resin that is not a crystalline resin.

### Operations

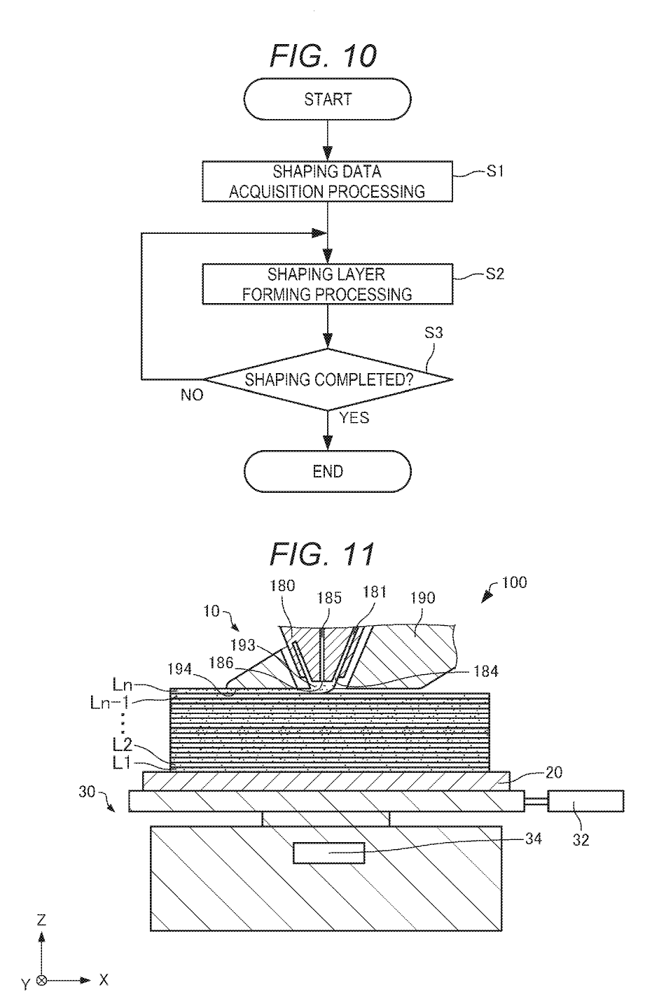

FIG. 10 is a flowchart illustrating operations of the three-dimensional shaping apparatus 100. Specifically, FIG. 10 is a flowchart illustrating processing of the control unit 40.

For example, a user operates an operation unit (not illustrated) to output, to the control unit 40, a processing start signal for starting processing. The operation unit includes, for example, a mouse, a keyboard, or a touch panel. When receiving the processing start signal, the control unit 40 starts the processing.

First, as illustrated in FIG. 10, in step S1, the control unit 40 performs shaping data acquisition processing of acquiring shaping data for shaping a three-dimensional shaped object.

The shaping data includes, for example, information on a type of the shaping material MR supplied from the shaping material supply unit 110, a type of the fiber material FB supplied from the fiber material supply unit 160, a movement path of the discharging unit 10 with respect to the stage 20, the amount of the plasticized material discharged from the discharging unit 10, and the like.

The shaping data is created by, for example, causing slicer software installed in a computer connected to the three-dimensional shaping apparatus 100 to read shape data. The shape data is data representing a target shape of a shaped object created using three-dimensional computer aided design (CAD) software, three-dimensional computer graphics (CG) software, or the like. As the shape data, for example, data in a standard triangulated language (STL) format or an additive manufacturing file format (AMF) is used. The slicer software divides the target shape of the shaped object into layers each having a predetermined thickness and creates shaping data for each of the layers. The shaping data is represented by a G code, an M code, or the like. The control unit 40 acquires shaping data from a computer connected to the three-dimensional shaping apparatus 100 or a recording medium such as a universal serial bus (USB) memory.

Next, as step S2, the control unit 40 performs shaping layer forming processing of forming a shaping layer by discharging the plasticized material and the fiber material FB to the stage 20.

Specifically, the control unit 40 plasticizes the shaping material supplied to between the flat screw 130 and the barrel 140 to generate the plasticized material, and discharges the plasticized material from the nozzle 180. Further, the control unit 40 drives the conveyance roller 164 of the fiber material supply unit 160 to supply the fiber material FB to the nozzle 180 and discharges the fiber material FB from the nozzle 180. The control unit 40 continues to generate the plasticized material until the shaping layer forming processing is completed.

Here, FIG. 11 is a cross-sectional view illustrating the shaping layer forming processing of the three-dimensional shaping apparatus 100. For convenience, the fiber material FB is not illustrated in FIG. 11.

As illustrated in FIG. 11, based on the acquired shaping data, while controlling the position changing unit 30 to change the relative positions of the discharging unit 10 and the stage 20, the control unit 40 controls the discharging unit 10 to discharge the plasticized material from the nozzle 180 toward the stage 20.

Specifically, before the shaping layer forming processing is started, that is, before formation of a shaping layer L1 as a first shaping layer is started, the nozzle 180 is disposed at an initial position in the -X-axis direction of an end portion of the stage 20 in the -X-axis direction. When the shaping layer forming processing is started, as illustrated in FIG. 11, the control unit 40 controls the position changing unit 30 to, for example, move the nozzle 180 in the +X-axis direction relative to the stage 20. When the nozzle 180 passes over the stage 20, the plasticized material is discharged from the nozzle 180. Accordingly, the shaping layer L1 is formed. In FIG. 11, shaping layers up to an n-th shaping layer Ln are shown, with n being any natural number. The Z-axis direction is a lamination direction of shaping layers constituting the shaped object.

In the shaping layer forming processing, the control unit 40 controls the conveyance roller 164 of the fiber material supply unit 160 based on the shaping data to discharge the fiber material FB from the nozzle 180. The control unit 40 may discharge the fiber material FB from the nozzle 180 at a portion of the shaped object for which the strength is desired to be increased based on the shaping data. The portion of the shaped object for which the strength is desired to be increased may be set by performing stress analysis in advance. Alternatively, the control unit 40 may continue discharging the fiber material FB from the nozzle 180 until the shaping layer forming processing is completed.

In the shaping layer forming processing, the control unit 40 drives the ultrasonic wave applying unit 190 based on the shaping data. The control unit 40 may drive the ultrasonic wave applying unit 190 at the portion of the shaped object for which the strength is desired to be increased based on the shaping data. Alternatively, the control unit 40 may continue driving the ultrasonic wave applying unit 190 until the shaping layer forming processing is completed. As illustrated in FIG. 11, the contact surface 194 of the ultrasonic wave applying unit 190 is in contact with the shaping layer deposited on the stage 20. A thickness of the shaping layer Ln is determined by a distance between the contact surface 194 and a shaping layer Ln-1. The distance between the contact surface 194 and the shaping layer Ln-1 is, for example, 0.1 mm or more and 0.2 mm or less.

Next, as illustrated in FIG. 10, in step S3, the control unit 40 performs determination processing of determining whether the formation of all the shaping layers is completed based on the shaping data.

When it is determined that the formation of all the shaping layers is not completed ("NO" in step S3), the control unit 40 returns the processing to step S2. The control unit 40 repeats steps S2 and S3 until it is determined in step S3 that the formation of all the shaping layers is completed.

On the other hand, when it is determined that the formation of all the shaping layers is completed ("YES" in step S3), the control unit 40 ends the processing.

### Action Effects

The three-dimensional shaping apparatus 100 includes the plasticizing unit 120 configured to plasticize at least a part of a shaping material containing a thermoplastic resin to generate a plasticized material, the fiber material supply unit 160 configured to supply a fiber material, the nozzle 180 configured to discharge the plasticized material and the fiber material toward the stage 20, and the ultrasonic wave applying unit 190 configured to apply ultrasonic waves to at least one of the plasticized material and the fiber material. The distance D1 between the nozzle 180 and the stage 20 is larger than the distance D2 between the ultrasonic wave applying unit 190 and the stage 20.

Therefore, in the three-dimensional shaping apparatus 100, strength of a shaped object can be improved. Specifically, in the three-dimensional shaping apparatus 100, the fiber material FB can be uniformly impregnated with the thermoplastic resin by the ultrasonic wave applying unit 190, and the strength of the shaped object can be improved. Further, a shaping layer can be laminated while being fused with a lower shaping layer by the ultrasonic wave applying unit 190, and strength at boundaries of adjacent shaping layers can be improved. Further, voids generated in the thermoplastic resin can be reduced by the ultrasonic wave applying unit 190, and the strength of the shaped object can be improved.

Further, in the three-dimensional shaping apparatus 100, since the distance D1 is larger than the distance D2, the plasticized material discharged from the first nozzle opening 184 can be stored in the storage portion 193 surrounded by the inner wall 192 of the ultrasonic wave applying unit 190. Since the fiber material FB is discharged from the second nozzle opening 186 in a state where the plasticized material is accumulated in the storage portion 193, the fiber material FB can be impregnated with the plasticized material in the storage portion 193.

In the three-dimensional shaping apparatus 100, the ultrasonic wave applying unit 190 is separated from the nozzle 180 and surrounds the nozzle 180 as viewed from the Z-axis direction. Therefore, in the three-dimensional shaping apparatus 100, it is possible to prevent the vibration for generating the ultrasonic waves by the ultrasonic wave applying unit 190 from being reduced by the nozzle 180.

In the three-dimensional shaping apparatus 100, the nozzle 180 includes the first nozzle flow channel 181 as a first flow channel that is a flow channel for the plasticized material and that has the first nozzle opening 184 for discharging the plasticized material, and the second nozzle flow channel 185 as a second flow channel that is a flow channel for the fiber material FB and that has the second nozzle opening 186 for discharging the fiber material FB. The first nozzle opening 184 has an annular shape as viewed from the Z-axis direction and surrounds the second nozzle opening 186. Therefore, in the three-dimensional shaping apparatus 100, the plasticized material and the fiber material FB can be uniformly mixed regardless of a direction in which the nozzle 180 moves relative to the stage 20 among directions orthogonal to the Z-axis direction.

In the three-dimensional shaping apparatus 100, the distance D3 between the first nozzle opening 184 and the stage 20 is larger than the distance D4 between the second nozzle opening 186 and the stage 20. Therefore, in the three-dimensional shaping apparatus 100, a large amount of the plasticized material can be stored in the storage portion 193, and the fiber material FB can be sufficiently impregnated with the plasticized material.

In the three-dimensional shaping apparatus 100, the outer edge 184a and the inner edge 184b of the first nozzle opening 184 are curved as viewed from the Z-axis direction. Therefore, in the three-dimensional shaping apparatus 100, the plasticized material and the fiber material FB can be uniformly mixed.

### Modifications of Three-Dimensional Shaping Apparatus

### First Modification

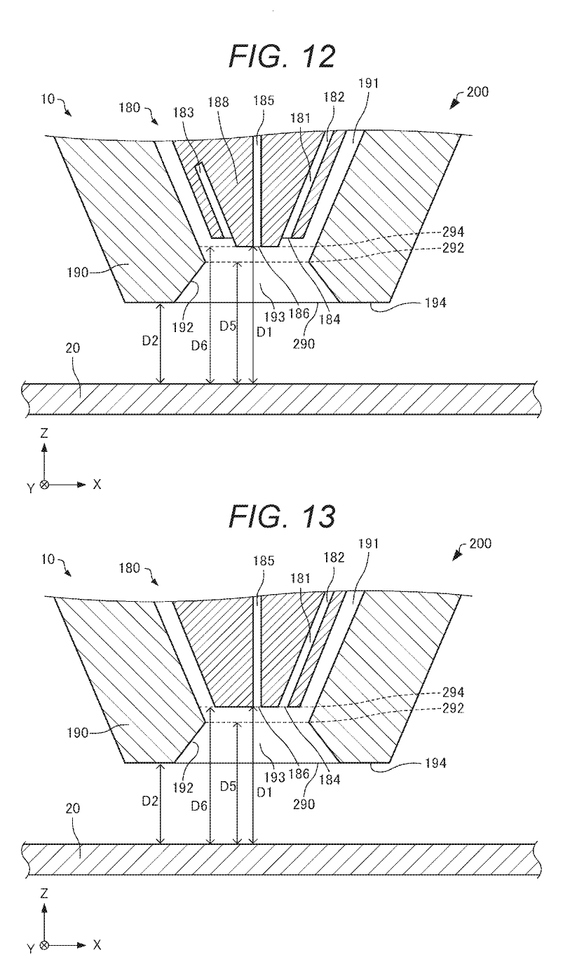

Next, a three-dimensional shaping apparatus according to a first modification of the embodiment will be described with reference to the drawings. FIG. 12 is a cross-sectional view schematically illustrating a three-dimensional shaping apparatus 200 according to the first modification of the embodiment. For convenience, in FIG. 12, illustration of members other than the stage 20, the nozzle 180, and the ultrasonic wave applying unit 190 is omitted.

Hereinafter, in the three-dimensional shaping apparatus 200 according to the first modification of the embodiment, points different from the example of the three-dimensional shaping apparatus 100 according to the embodiment described above will be described, and a description of the same points will be simplified or omitted. The same applies to the three-dimensional shaping apparatus according to second and third modifications of the embodiment described later.

In the three-dimensional shaping apparatus 200, as illustrated in FIG. 12, the shape of the through hole 191 of the ultrasonic wave applying unit 190 is different from that of the three-dimensional shaping apparatus 100 described above.

In the three-dimensional shaping apparatus 200, the through hole 191 of the ultrasonic wave applying unit 190 has a first opening 290, a second opening 292, and a third opening 294.

The first opening 290 is an opening of the through hole 191 closer to the stage 20. In the illustrated example, the first opening 290 is located at an end of the through hole 191 in the -Z-axis direction. As viewed from the Z-axis direction, the first opening 290 has, for example, a circular shape. A diameter of the first opening 290 is, for example, 0.1 mm or more and 0.2 mm or less. A distance between the first opening 290 and the stage 20 is the same as the distance D2 between the ultrasonic wave applying unit 190 and the stage 20.

The second opening 292 is located above the first opening 290. The second opening 292 is closer to the nozzle 180 than is the first opening 290. The second opening 292 communicates with the first opening 290. The second opening 292 is located between the first opening 290 and the third opening 294. A distance D5 between the second opening 292 and the stage 20 is smaller than the distance D1 between the nozzle 180 and the stage 20. An area of the first opening 290 is larger than an area of the second opening 292. The through hole 191 has a tapered shape in which the area gradually decreases from the first opening 290 to the second opening 292 in the +Z-axis direction.

The third opening 294 is located above the second opening 292. The third opening 294 communicates with the second opening 292. A distance D6 between the third opening 294 and the stage 20 is, for example, the same as the distance D1 between the nozzle 180 and the stage 20. A distance between the first opening 290 and the third opening 294 is, for example, 0.1 mm or more and 0.3 mm or less, and is preferably about 0.2 mm. The area of the second opening 292 is smaller than the area of the third opening 294. The through hole 191 has a reverse tapered shape in which the area gradually increases from the second opening 292 to the third opening 294 in the +Z-axis direction. At the second opening 292, the through hole 191 is narrowed. The area of the third opening 294 is, for example, smaller than the area of the first opening 290.

In the three-dimensional shaping apparatus 200, the ultrasonic wave applying unit 190 has the first opening 290 and the second opening 292 that communicates with the first opening 290 and that is closer to the nozzle 180 than is the first opening 290, the distance D5 between the second opening 292 and the stage 20 is smaller than the distance D1 between the nozzle 180 and the stage 20, and the area of the first opening 290 is larger than the area of the second opening 292. Therefore, in the three-dimensional shaping apparatus 200, for example, as compared to a case where the area of the first opening is the same as the area of the second opening, it is possible to reduce the possibility that the fiber material FB discharged from the second nozzle opening 186 is broken and damaged when the nozzle 180 moves relative to the stage 20. Accordingly, shaping accuracy of a shaped object can be improved.

As illustrated in FIG. 13, the first nozzle flow channel 181 may not include the surrounding portion 183 as illustrated in FIG. 12. In this case, the first nozzle opening 184 does not surround the second nozzle opening 186 as viewed from the Z-axis direction. In the example illustrated in FIG. 13, a position of the first nozzle opening 184 and a position of the second nozzle opening 186 are the same in the Z-axis direction.

In the three-dimensional shaping apparatus 200, the ultrasonic wave applying unit 190 has the third opening 294 communicating with the second opening 292, the second opening 292 is located between the first opening 290 and the third opening 294, the distance D6 between the third opening 294 and the stage 20 and the distance D1 between the nozzle 180 and the stage 20 are the same, and the area of the second opening 292 is smaller than the area of the third opening 294. Therefore, in the three-dimensional shaping apparatus 200, the alignment of the discharge of the plasticized material to the stage 20 can be easily performed as compared to a case where the area of the second opening is the same as the area of the third opening. Accordingly, the shaping accuracy of a shaped object can be improved.

### Second Modification

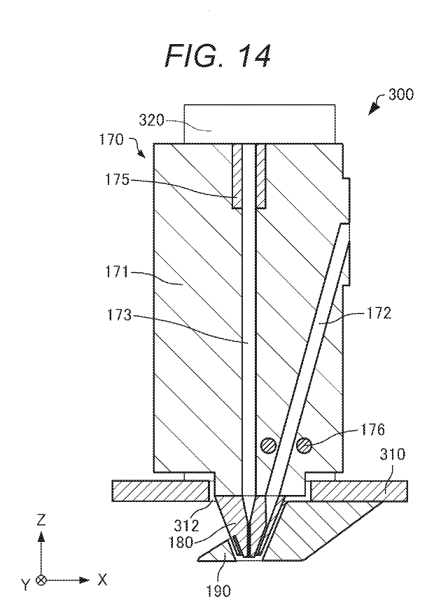

Next, a three-dimensional shaping apparatus according to the second modification of the embodiment will be described with reference to the drawings. FIG. 14 is a cross-sectional view schematically illustrating a three-dimensional shaping apparatus 300 according to the second modification of the embodiment. For convenience, in FIG. 14, members other than the block body 170, the nozzle 180, the ultrasonic wave applying unit 190, a support 310, and a drive unit 320 are not illustrated.

In the three-dimensional shaping apparatus 100 described above, as illustrated in FIG. 2, the ultrasonic wave applying unit 190 is fixed to the block body 170.

In contrast, in the three-dimensional shaping apparatus 300, as illustrated in FIG. 14, the ultrasonic wave applying unit 190 is fixed to the support 310.

The discharging unit 10 of the three-dimensional shaping apparatus 300 includes, for example, the support 310 and the drive unit 320. The support 310 supports the drive unit 320 and the ultrasonic wave applying unit 190. For example, a through hole 312 is formed in the support 310. The through hole 312 runs through the support 310 in the Z-axis direction. In the illustrated example, the block body 170 and the nozzle 180 are located in the through hole 312.

The drive unit 320 supports the block body 170. The drive unit 320 moves the block body 170 in the Z-axis direction. As the block body 170 moves, the nozzle 180 moves relative to the ultrasonic wave applying unit 190. That is, the nozzle 180 is movable relative to the ultrasonic wave applying unit 190 in the Z-axis direction. The drive unit 320 includes, for example, a ball screw, a stepping motor, and a linear guide. Driving of the drive unit 320 is controlled by the control unit 40.

The drive unit 320 may move the nozzle 180 relative to the ultrasonic wave applying unit 190 by moving the ultrasonic wave applying unit 190 in a state where the block body 170 is fixed. Although not illustrated, the drive unit 320 may be coupled to, for example, the screw case 122 instead of the block body 170, and may move the nozzle 180 relative to the ultrasonic wave applying unit 190 by moving the screw case 122.

In the three-dimensional shaping apparatus 300, the nozzle 180 is movable relative to the ultrasonic wave applying unit 190 in the Z-axis direction. Therefore, in the three-dimensional shaping apparatus 300, for example, the position of the nozzle 180 with respect to the ultrasonic wave applying unit 190 in the Z-axis direction can be adjusted based on the magnitude of the diameter of the fiber material FB supplied from the fiber material supply unit 160. For example, when the diameter of the fiber material FB is large, a volume of the storage portion 193 can be increased by moving the nozzle 180 in the +Z-axis direction with respect to the ultrasonic wave applying unit 190.

### Third Modification

Next, a three-dimensional shaping apparatus according to a third modification of the embodiment will be described with reference to the drawings. FIG. 15 is a cross-sectional view schematically illustrating a three-dimensional shaping apparatus 400 according to the third modification of the present embodiment.

In the three-dimensional shaping apparatus 100 described above, as illustrated in FIG. 2, the communication hole 146 formed in the barrel 140 extends in the X-axis direction.

In contrast, in the three-dimensional shaping apparatus 400, as illustrated in FIG. 15, the communication hole 146 extends in a direction inclined with respect to the X-axis direction. The communication hole 146 extends obliquely downward. Therefore, in the three-dimensional shaping apparatus 400, a plasticized material can be smoothly guided to the nozzle 180. The first block flow channel 172 extends in the same direction as the communication hole 146.

### Experimental Example

### X-ray CT Observation

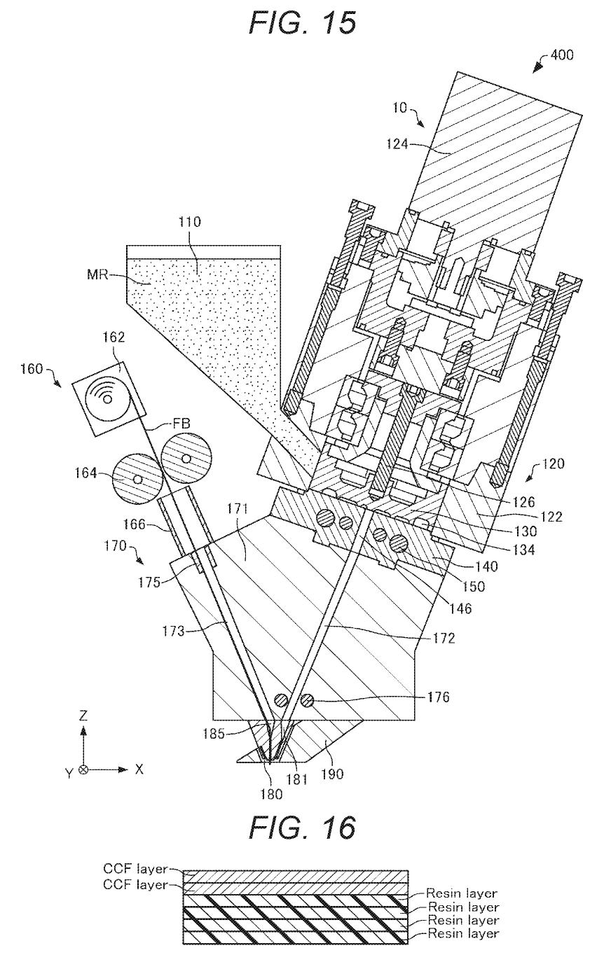

A shaped object was shaped using a three-dimensional shaping apparatus, and the shaped object was observed by X-ray computed tomography (CT). FIG. 16 is a cross-sectional view schematically illustrating the shaped object. As illustrated in FIG. 16, the shaped object includes four resin layers and two CCF layers. The resin layer is formed by mixing short fibers of carbon fibers with a resin. The CCF layer is formed by impregnating a fiber bundle of carbon fibers with a resin. The resin contained in the resin layer and the CCF layer was polyamide 6 (nylon 6). In Example 1, the shaped object was shaped by applying ultrasonic waves by the ultrasonic wave applying unit. In Comparative Example 1, a shaped object was shaped without applying ultrasonic waves.

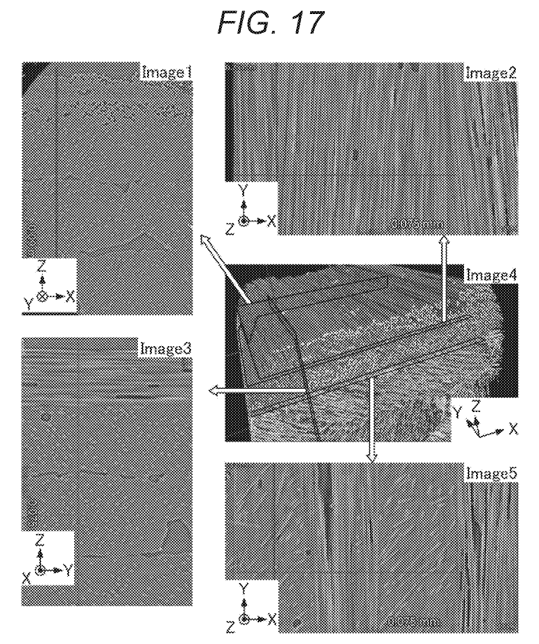

FIG. 17 is an X-ray CT image of the shaped object of Example 1. In FIG. 17, Image4 is a perspective view of the shaped object, and Image1, Image3, and Image5 are cross-sectional views of the shaped object taken along a virtual plane indicated in Image4.

In Image1, the carbon fibers in the CCF layer and the short fibers in the resin layer are represented by a white dot pattern. Image2 is a cross-sectional view of boundaries of the two CCF layers, and the carbon fibers in the CCF layer are represented in a white linear shape. In Image3, the carbon fibers in the CCF layer are represented in a white linear shape, and the short fibers in the resin layer are represented by a white dot pattern. Image5 is a cross-sectional view of boundaries of the CCF layer and the resin layer, the carbon fibers in the CCF layer are represented in a white linear shape, and the short fibers in the resin layer are represented by short white lines extending in an oblique direction.

In FIG. 17, it was found from Image1 and Image3 that the two CCF layers were seamlessly bonded to each other. From Image1, Image3, and Image5, it was found that the layers were mutually diffused at the boundaries of the CCF layer and the resin layer, and the CCF layer and the resin layer were seamlessly bonded to each other. From Image2, it was found that the carbon fibers were uniformly dispersed in the CCF layer and the adjacent carbon fibers were well fused.

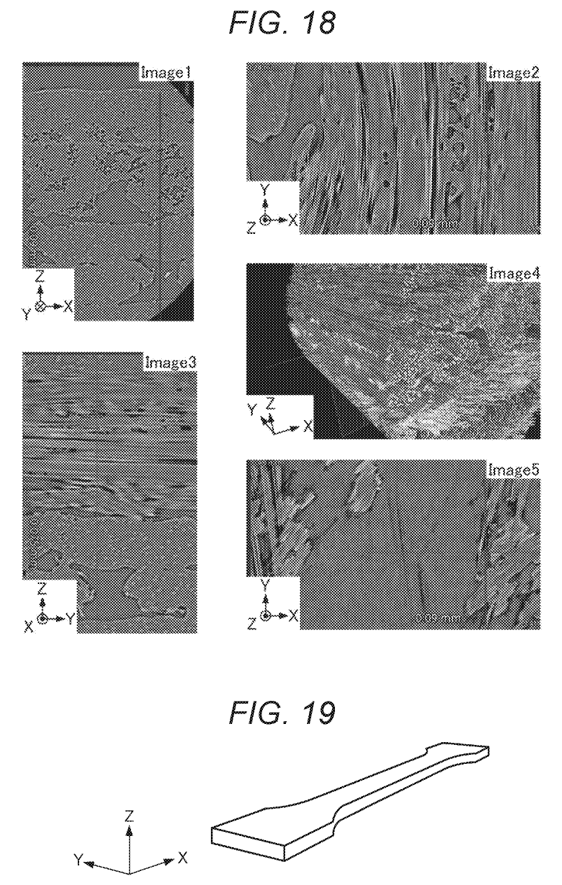

FIG. 18 is an X-ray CT image of the shaped object of Comparative Example 1 to which ultrasonic waves were not applied. Image1 to Image5 in FIG. 18 correspond to Image1 to Image5 in FIG. 17.

In FIG. 18, the density and voids of the carbon fibers were confirmed at boundaries of the two CCF layers from Image1. From Image1, Image3 and Image5, a clear boundary line was confirmed at the boundaries of the CCF layer and the resin layer, and it was found that the layers were not mutually diffused. From Image2, voids were confirmed, and it was found that the carbon fibers were not uniformly dispersed in the CCF layer.

From the X-ray CT image observation described above, it was found that, by applying ultrasonic waves to shape the shaped object, adjacent layers could be mutually diffused and fused at the boundaries of the resin layer and the CCF layer and the boundaries of the CCF layer and the CCF layer. Therefore, it was found that the strength of the shaped object could be improved by ultrasonic waves. Furthermore, it was found that the carbon fibers in the CCF layer could be uniformly opened by applying ultrasonic waves. Furthermore, it was found that voids could be reduced by applying ultrasonic waves.

### Tensile Test in Shaping Layer

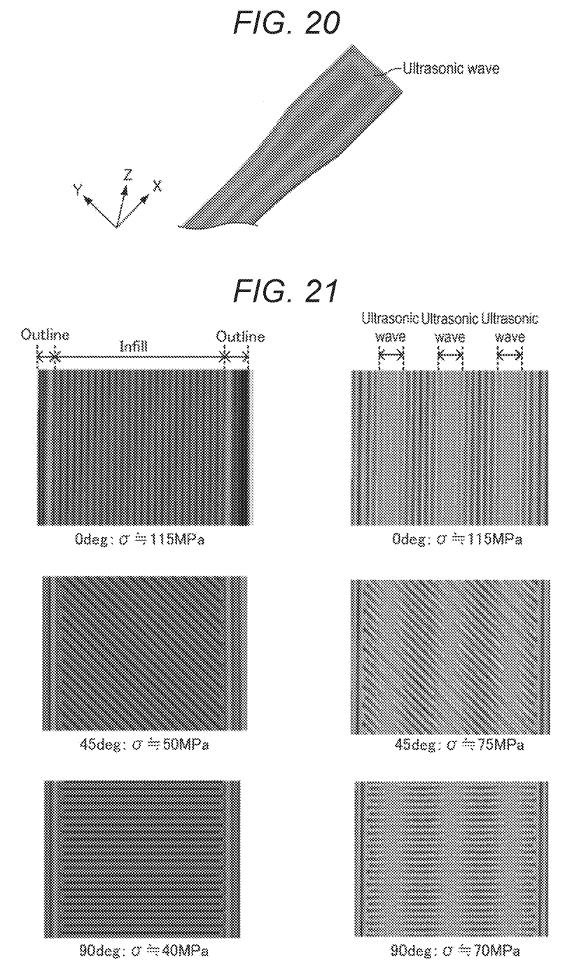

A test piece as illustrated in FIG. 19 was shaped as a shaped object by a three-dimensional shaping apparatus. The test piece is suitable for the "ASTM D638 plastic tensile test method". A tensile test was performed by pulling the test piece in the X-axis direction. The test piece was manufactured by discharging an ABS resin from a nozzle without using a fiber material. Shaping conditions were an s/n of 60, a line width of 0.5 mm, a barrel rotation speed of 4.1 rpm, and a scanning speed of 50 mm/s. A test piece to which ultrasonic waves were not applied and a test piece to which ultrasonic waves were applied as illustrated in FIG. 20 were prepared. As illustrated in FIG. 20, the ultrasonic waves were applied along an outer edge of the test piece as viewed from the Z-axis direction, and further applied to a center of the test piece along the X-axis direction. The line width of the ultrasonic waves was set to 4 mm.

As illustrated in FIG. 21, a test piece was produced by changing a nozzle path (infill path) of the three-dimensional shaping apparatus at three levels with respect to the X-axis direction. Specifically, a test piece for which an infill path of 0° with respect to the X-axis direction, that is, parallel to the X-axis direction was set, a test piece for which an infill path of 45° with respect to the X-axis direction was set, and a test piece for which an infill path of 90° with respect to the X-axis direction, that is, parallel to the Y-axis direction was set were shaped.

FIG. 21 illustrates results of the tensile test. As illustrated in FIG. 21, the effect of ultrasonic waves could not be confirmed at the infill path of 0°, but strength of the test piece was improved by applying ultrasonic waves in the cases of the infill paths of 45° and 90°. According to the tensile test, it was found that the strength of the shaping layer could be improved by ultrasonic waves even for a shaped object shaped with a resin alone without using a fiber material.

### Tensile Test between Shaping Layers

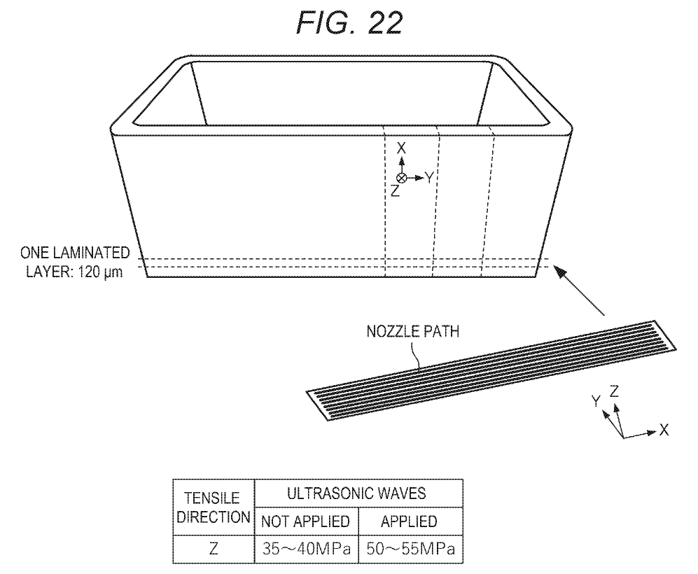

A plurality of shaping layers were laminated by the three-dimensional shaping apparatus to shape a shaped object as illustrated in FIG. 22. The shaped object had a width of 100 mm, a length of 50 mm, and a height of 40 mm. Shaping conditions were the same as the shaping conditions in "3.2. Tensile Test in Shaping Layer". A thickness of one shaping layer was 120 μm. A shaped object to which ultrasonic waves were not applied and a shaped object to which ultrasonic waves were applied each time one shaping layer was formed were prepared. Such two types of shaped objects were cut along broken lines shown in FIG. 22 into individual pieces, and a tensile test was performed on the individual pieces. A size of the individual piece was 10 mm in the X-axis direction, 4 mm in the Y-axis direction, and 40 mm in the Z-axis direction. For the individual piece, a nozzle path and a path of the ultrasonic wave applying unit were parallel to the X axis. The nozzle path had a width of 0.5 mm in the Y-axis direction, and eight nozzle paths were arranged side by side in the Y-axis direction. One path of the ultrasonic wave applying unit having a width of 4 mm in the Y-axis direction was set.

FIG. 22 illustrates results of the tensile test. The strength of the individual piece was also improved by applying the ultrasonic waves in the Z-axis direction that was an index of the strength between the shaping layers. According to the tensile test, it was found that the strength between the shaping layers could be improved by ultrasonic waves even for a shaped object shaped with a resin alone without using a fiber material.

The embodiment and modifications described above are merely examples, and the present disclosure is not limited thereto. For example, the embodiment and the modifications can also be combined as appropriate.

The present disclosure includes a configuration that is substantially the same as the configuration described in the embodiment, such as a configuration having the same function, using the method, and providing the same result, or a configuration having the same object and providing the same advantages. The present disclosure further includes a configuration in which a non-essential portion of the configuration described in the embodiment is replaced with another portion. The present disclosure includes a configuration that has the same action effects as those of the configuration described in the embodiment or a configuration that can achieve the same objects as those achieved by the configuration. The present disclosure includes a configuration obtained by adding a publicly-known technique to the configuration described in the embodiment.

The following contents are derived from the embodiment and the modifications described above.

A three-dimensional shaping apparatus according to an aspect is configured including:

a plasticizing unit configured to plasticize at least a part of a shaping material containing a thermoplastic resin to generate a plasticized material;

a fiber material supply unit configured to supply a fiber material;

a nozzle configured to discharge the plasticized material and the fiber material toward a stage; and

an ultrasonic wave applying unit configured to apply ultrasonic waves to at least one of the plasticized material and the fiber material, in which

a distance between the nozzle and the stage is larger than a distance between the ultrasonic wave applying unit and the stage.

According to the three-dimensional shaping apparatus, strength of a shaped object can be improved.

The three-dimensional shaping apparatus according to an aspect, in which

the ultrasonic wave applying unit may be separated from the nozzle and surround the nozzle as viewed from a lamination direction of a shaped object.

According to the three-dimensional shaping apparatus, it is possible to prevent vibration for generating ultrasonic waves of the ultrasonic wave applying unit from being reduced by the nozzle.

The three-dimensional shaping apparatus according to an aspect, in which

the nozzle may include

a first flow channel that is a flow channel for the plasticized material and has a first nozzle opening for discharging the plasticized material, and

a second flow channel that is a flow channel for the fiber material and has a second nozzle opening for discharging the fiber material, and

the first nozzle opening may have an annular shape as viewed from the lamination direction and surround the second nozzle opening.

According to the three-dimensional shaping apparatus, the plasticized material and the fiber material can be uniformly mixed regardless of a direction in which the nozzle moves relative to the stage among directions orthogonal to the lamination direction.

The three-dimensional shaping apparatus according to an aspect, in which

a distance between the first nozzle opening and the stage may be larger than a distance between the second nozzle opening and the stage.

According to the three-dimensional shaping apparatus, the fiber material can be sufficiently impregnated with the plasticized material.

The three-dimensional shaping apparatus according to an aspect, in which

the ultrasonic wave applying unit may include

a first opening, and

a second opening that communicates with the first opening and is closer to the nozzle than is the first opening,

a distance between the second opening and the stage may be smaller than the distance between the nozzle and the stage, and

an area of the first opening may be larger than an area of the second opening.

According to the three-dimensional shaping apparatus, it is possible to reduce a possibility of damaging the fiber material.

The three-dimensional shaping apparatus according to an aspect, in which

the ultrasonic wave applying unit may include a third opening communicating with the second opening,

the second opening may be located between the first opening and the third opening,

a distance between the third opening and the stage may be same as the distance between the nozzle and the stage, and

the area of the second opening may be smaller than the area of the third opening.

According to the three-dimensional shaping apparatus, it is possible to easily perform alignment of discharge of the plasticized material to the stage.

The three-dimensional shaping apparatus according to an aspect, in which

an outer edge and an inner edge of the first nozzle opening may be curved as viewed from the lamination direction.

According to the three-dimensional shaping apparatus, the plasticized material and the fiber material can be uniformly mixed.

The three-dimensional shaping apparatus according to an aspect, in which

the nozzle may be movable relative to the ultrasonic wave applying unit in a lamination direction of a shaped object.

According to the three-dimensional shaping apparatus, a position of the nozzle with respect to the ultrasonic wave applying unit in the lamination direction of the shaped object can be adjusted.

What is claimed is:

1. A three-dimensional shaping apparatus comprising:
a plasticizing unit configured to plasticize at least a part of a shaping material containing a thermoplastic resin to generate a plasticized material;
a fiber material supply unit configured to supply a fiber material;
a nozzle configured to discharge the plasticized material and the fiber material toward a stage; and
an ultrasonic wave applying unit configured to apply ultrasonic waves to at least one of the plasticized material and the fiber material, wherein
a distance between the nozzle and the stage is larger than a distance between the ultrasonic wave applying unit and the stage.

2. The three-dimensional shaping apparatus according to claim 1, wherein
the ultrasonic wave applying unit is separated from the nozzle and surrounds the nozzle as viewed from a lamination direction of a shaped object.

3. The three-dimensional shaping apparatus according to claim 2, wherein
the nozzle includes
a first flow channel that is a flow channel for the plasticized material and has a first nozzle opening for discharging the plasticized material, and
a second flow channel that is a flow channel for the fiber material and has a second nozzle opening for discharging the fiber material, and
the first nozzle opening has an annular shape as viewed from the lamination direction and surrounds the second nozzle opening.

4. The three-dimensional shaping apparatus according to claim 3, wherein
a distance between the first nozzle opening and the stage is larger than a distance between the second nozzle opening and the stage.

5. The three-dimensional shaping apparatus according to claim 2, wherein
the ultrasonic wave applying unit includes
a first opening, and
a second opening that communicates with the first opening and is closer to the nozzle than is the first opening,
a distance between the second opening and the stage is smaller than the distance between the nozzle and the stage, and
an area of the first opening is larger than an area of the second opening.

6. The three-dimensional shaping apparatus according to claim 5, wherein
the ultrasonic wave applying unit includes a third opening communicating with the second opening,
the second opening is located between the first opening and the third opening,
a distance between the third opening and the stage is same as the distance between the nozzle and the stage, and
the area of the second opening is smaller than the area of the third opening.

7. The three-dimensional shaping apparatus according to claim 3, wherein
an outer edge and an inner edge of the first nozzle opening are curved as viewed from the lamination direction.

8. The three-dimensional shaping apparatus according to claim 1, wherein
the nozzle is movable relative to the ultrasonic wave applying unit in a lamination direction of a shaped object.
